(19) United States
(12) Patent Application Publication
(10) Pub. No.: US 2026/0273754 A1
(43) Pub. Date: Sep. 17, 2026

(54) A METHOD OF CONTROLLING A MAINTENANCE OPERATION APPARATUS OF A RECOVERY BOILER AND A MAINTENANCE OPERATION APPARATUS

(71) Applicant: ANDRITZ OY, Helsinki (FI)

(72) Inventors: Jarkko BRUNOU, Savonlinna (FI); Jokke JANTUNEN, Varkaus (FI); Heikki LAPPALAINEN, Varkaus (FI)

(21) Appl. No.: 19/168,751

(22) PCT Filed: Mar. 5, 2024
(86) PCT No.: PCT/FI2024/050088

§ 371 Date: Sep. 24, 2025

(30) Foreign Application Priority Data
Mar. 24, 2023 (FI) 20235345

(51) Int. Cl. B25J 9/16; B25J 11/00; B25J 15/00; G05D 105/10

(52) U.S. Cl. CPC B25J 9/1692; B25J 9/1694; B25J 11/0085; B25J 15/0019; G05D 2105/10

(57) ABSTRACT

A method of controlling a maintenance operation apparatus (10) of a recovery boiler (11) including: defining a position of a fixed world coordinate system (20) at a recovery boiler (11); defining a position of an initial base coordinate system (21) of a maintenance object (12) that is at a chosen point of a maintenance object (S1-S14) determined in the fixed world coordinate system (20) in an initial temperature of the recovery boiler (11); defining a position of a corrected base coordinate system (22) of the maintenance object in the fixed world coordinate system at the position of the chosen point in the fixed world coordinate system in a transited temperature of the recovery boiler, (11); controlling a tool moving device (R1-R5) to perform the maintenance operation of the maintenance object in the corrected base coordinate system.

### FIELD OF THE INVENTION

The invention relates to a method of controlling a maintenance operation apparatus of a recovery boiler and a maintenance operation apparatus.

### BACKGROUND OF THE INVENTION

The main fuel being burned in a recovery boiler is black liquor. Secondary fuels such as oil, natural gas or some renewable fuels like tar or tall oil are used during startup and shutdown. In normal operation only black liquor is fired by employing specialized nozzles that are designed to atomize the liquid fuel for optimum combustion. The purpose of the atomization is to enable rapid drying and volatilization of the organic material in the fuel which consists mostly of lignin and hemicellulose being separated from wood fibers in the pulping process.

In addition to organic material black liquor contains chemicals used in the kraft pulp process. These inorganic materials, mostly sodium sulfate and sodium carbonate will melt in the heat of the combusting organic material. Molten salt (smelt) flows out of the boiler through the smelt spouts at the bottom of the boiler furnace to a dissolving tank.

The combustion of black liquor is a delicate process where the balance of firing temperature and pressure, nozzle angle and type and liquor quality need to be maintained. The effects of poor liquor firing include accumulation of deposits in the heat surfaces, inefficient char smelt bed reactions and increased flue gas pollutants. To avoid inappropriate firing and ensure successful operation the burner must be kept free of smelt and char deposits. Especially, these tend to pile-up and cause plugging to the objects of the boiler's furnace having irregularities such as smelt spouts, liquor gun openings as well as cleaning and inspection hatches. Therefore, regular cleaning operations of these objects are unavoidable to secure optimal and undisturbed process performance. Traditionally, such maintaining operations were carried out manually by using suitable hand-tools, but due to the high safety risks in working at the region with possible hot smelt splashes automated and/or robotized maintaining apparatuses for these tasks have been increasingly employed during the last decades.

The known automated maintaining systems and apparatuses such as described e.g., in publications WO 2018/229334, EP1914477 B1, EP 2024559 B1 or U.S. Pat. No. 55,542,5650 B have been recently employed e.g., in reducing the above-mentioned safety risks for the employees. However, in some respects further improvement for such arrangements is still needed. For instance, one drawback in the known automated solutions applied presently relate to their position control methods. This is because the known maintenance operation apparatuses are not adapted to compensate large temperature changes and thermal expansion which typically occurs in recovery boiler walls when the burning process is switched between its different phases of operation i.e., from startup to normal operation and from normal operation to shutdown. Effects of such thermal expansion is in the most cases unpredictable, among others due to the phenomenon's non-linearities caused by the structural complexity of the boiler. Thus, for instance, mere predetermined compensations based on simple linear calculation models may not solve these problems properly.

### SUMMARY OF THE INVENTION

The object of the present invention is to provide an improved method of controlling a maintenance operation apparatus of a recovery boiler by means of which the maintenance operations carried out by the apparatus can be controlled by considering displacements of the objects to be maintained caused by the thermal expansions occurring in the recovery boiler wall due to temperature transitions during the different operation phases of the recovery boiler. Furthermore, the aim of the invention is to provide apparatus for carrying out maintenance operations that is controlled according to the method of the invention.

The above-described drawbacks are rectified by the method of the invention because in the method an initial base coordinate system which coincides with an object to be maintained in a fixed world coordinate system and in which the maintenance operation apparatus carries out the maintenance operation is determined such that the initial base coordinate system is transferred from its initial position and orientation in to its actual position and orientation, i.e., where it truly locates after occurrence of the displacements caused by the thermal expansion occurring in a recovery boiler during its operation. To put it more precisely, the method according to the invention is characterized by what is described in the independent claim 1 and the apparatus by what is described in the independent claim 16. The dependent claims 2-15 describe advantageous embodiments of the method as well as the dependent claims 17 and 18 the advantageous embodiments of the apparatus.

An advantage of the method according to the invention is that the by means of it the control system of the maintenance apparatus can compensate misalignments and dislocations of the objects to be maintained caused by the thermal expansion. Therefore, by means of the method according to the invention maintenance operations carried out for objects to be maintained in a recovery boiler are accomplished safely and reliably regardless of the displacements of the objects caused by the temperature transitions occurring in the recovery boiler. In practice, this means that maintenance operation apparatus is always automatically adapted to work according to the prevailing temperature of the recovery boiler. Thus, for instance in case of cleaning a smelt spout the smelt spout cleaning tool being moved by a smelt spout cleaning apparatus remain always aligned precisely in a desired position at the smelt spout to be cleaned regardless of the operation phase of the recovery boiler. This ensures smooth and effective cleaning cycles and prevents uncertainty of the control and possible damages to the smelt spouts and/or cleaning tools that relates to the known control methods.

### BRIEF DESCRIPTION OF THE DRAWINGS

In the following, the invention will be described in more detail with reference to the appended drawings in which:

FIG. 1 shows a principal drawing on determining a temperature corrected base coordinate system from an initial base coordinate system in a world coordinate system,

FIG. 2 shows an example embodiment of the maintenance operation apparatus that is a smelt spout cleaning apparatus of a recovery boiler and that is controlled according to the method of the invention, seen obliquely from above,

FIG. 3 shows enlarged view of a smelt spout of the recovery boiler seen obliquely from above and showing how an initial base coordinate system is disposed at the smelt spout in case of the smelt spout cleaning apparatus of FIG. 2,

FIG. 4 shows a principle drawing depicting location of the world coordinate system and locations of the initial base coordinate systems in respect of the smelt spouts in the method for controlling the maintenance operation apparatus applied in the embodiment depicted in FIGS. 2 and 3,

FIG. 5 shows top view of the maintenance operation apparatus and a how the measurement sensors for determining positions of the smelt spouts are positioned in respect of the smelt spouts and the recovery boiler,

FIG. 6 shows top view of the embodiment of the maintenance operation apparatus shown in the FIGS. 2-5 and a principal drawing therein showing displacements caused by rotation of the recovery boiler wall in respect of Y axis due to thermal expansion, and

FIG. 7 shows a front view of the embodiment of the maintenance operation apparatus depicted in the FIGS. 2-6 and a principal drawing therein showing displacements caused by rotation of the recovery boiler wall in respect of X axis due to thermal expansion.

### DETAILED DESCRIPTION OF SOME ADVANTAGEOUS EMBODIMENTS

The method according to the present invention may be applied for several different maintenance operations of a recovery boiler, for instance such tasks as smelt spout cleaning, liquor gun opening cleaning or inspection hatch opening cleaning. Thus, in this respect it is generally discussed on controlling maintenance operations carried out by a maintenance operation apparatus which is meant any such operation that is regularly or occasionally carried out for the recovery boiler.

Maintenance operation apparatus is meant in the present application an apparatus that comprises a control unit by means of which the physical (moving) parts of the apparatus can be controlled automatically according to a control program being executed in the control unit. Thus, the control unit comprises e.g., a computer or other data processing device into which the said control program can be programmed and/or installed as well as executed accordingly. The control unit is further equipped with suitable control hardware to control electrically, pneumatically and/or hydraulically operated actuators arranged to move the physical parts of the maintenance operation apparatus herein called as a tool moving device. Typically, the tool moving device of the maintenance apparatus may be formed e.g., of an articulated industrial robot with suitable number of degrees of freedom. One maintenance operation apparatus may include one or more tool moving devices.

Maintenance tools which are applied in the maintenance operation may be chosen according to the maintenance operation. For instance, in smelt spout cleaning smelt spout cleaning tools are used. However, maintenance tool may be also some multipurpose tool suitable for several different maintenance operations or any specific maintenance tool being designed for its intended purpose. The maintenance operation apparatus may comprise several maintenance tools. Preferably, it has at least one maintenance tool per each tool moving device.

Generally, the method of controlling a maintenance operation includes at least following steps:
a) defining a position of a fixed world coordinate system at the recovery boiler,
b) defining a position of an initial base coordinate system of the at least one maintenance object that is at a chosen point of the at least one maintenance object determined in the fixed world coordinate system in an initial temperature of the recovery boiler,
c) defining a position of a corrected base coordinate system of the at least one maintenance object in the fixed world coordinate system that is at the position of the chosen point in the fixed world coordinate system in a transited temperature of the recovery boiler,
d) controlling a tool moving device to carry out the maintenance operation of the at least one maintenance object in the corrected base coordinate system.

Defining a position of the corrected base coordinate system may be accomplished for instance such that the tool moving device is controlled to move the maintenance tool to the position of the chosen point at the at least one maintenance object in transited temperature and recording the coordinates of the chosen point in the fixed world coordinate system. Such controlling may be accomplished manually or automatically. Manual definition may be accomplished by controlling the tool moving device to move the tool in a predetermined reference position. Automatic defining may be accomplished e.g., with the help of suitable location device (such as RFID tag) at the object which would indicate the reference position of an object to be maintained to the control unit.

In an embodiment of the method the position of the corrected base coordinate system is determined at least partly by calculating the displacement of the initial base coordinate system caused by the thermal expansion of the recovery boiler wall due to the temperature transition.

In an embodiment of the method at least the fixed world coordinate system is three-dimensional Cartesian coordinate system and determination of the position coordinates (i.e., position coordinates of the origin) of the corrected base coordinate system is calculated by using following equations:

$${X}^{′} = X + Δ X \qquad ( 1 )$$

$${Y}^{′} = Y + Δ Y \qquad ( 2 )$$

$${Z}^{′} = Z + Δ Z \qquad ( 3 )$$

wherein
X′, Y′, Z′ coordinates are position coordinates of the corrected base coordinate system in the fixed world coordinate system.
X, Y, Z coordinates are position coordinates of the initial base coordinate system in the fixed world coordinate system.
ΔX, ΔY, ΔZ are position coordinate displacements of the of the initial base coordinate system due to thermal expansion in the fixed word coordinate system.

In case when the method comprises controlling of the maintenance operation of at least two maintenance objects arranged adjacent to each other at the recovery boiler Y axis denotes direction along a line between the at least two, adjacent maintenance objects, X axis denotes direction perpendicular to Y axis being in the same plane as X axis and Z axis denotes direction being perpendicular to the plane defined by X and Y axes.

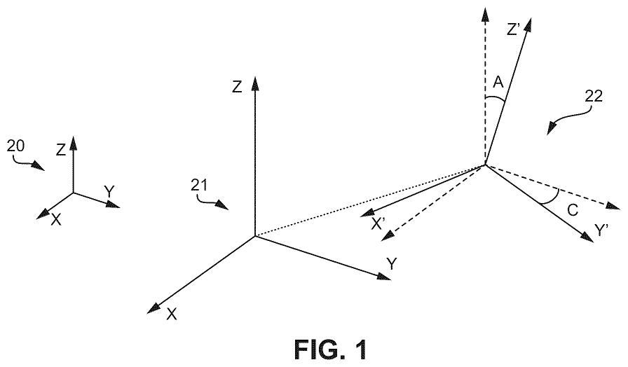

Typically, one initial base coordinate system and one corrected base coordinate system per each of the at least two maintenance objects are determined. Thus, the tool moving device is controlled to carry out the maintenance operation for each of the at least two maintenance objects in its respective corrected base coordinate system. Furthermore, in addition to such embodiments, the position coordinate displacements ΔX, ΔY and ΔZ the correction includes rotation of coordinate axes of the initial base coordinate system due to rotation of the recovery boiler wall caused by the thermal expansion. Thermal expansions of other parts of the recovery boiler than recovery boiler wall may be also considered but, in most cases, these are considered negligible. Rotation angles A and C of the coordinate axes of the initial base coordinate system shown in the FIG. 1 are determined by equations:

$$A = arctan ( Δ {X}_{2} - Δ {X}_{1} ) / ( {Y}_{2} - {Y}_{1} ) \qquad ( 4 )$$

$$C = arctan ( Δ {Z}_{2} - Δ {Z}_{1} / ( {Y}_{2} - {Y}_{1} ) , \qquad ( 5 )$$

wherein
A is a rotation angle of Y-axis in respect of X-axis
C is rotation angle of Y-axis in respect of Z-axis
Y₁ is a first Y position
Y₂ is a second Y position
ΔX₁ is displacement in the X direction occurring in the position Y₁
ΔX₂ is displacement in the X direction occurring in the position Y₂
ΔZ₁ is displacement in the Z direction occurring in the position Y₁
ΔZ₂ is displacement in the Z direction occurring in the position Y₂

In an embodiment the deformation of the recovery boiler wall caused by the temperature transition is measured by at least one displacement sensor placed in a known position at the recovery boiler. The measurement results of the at least one displacement measurement sensor is used in determination of the initial base coordinate system displacement to determine the position of the corrected base coordinate system. In case there are at least two displacement sensors placed in at least two different positions they may be used for determining displacements occurring in at least two different positions at the recovery boiler. This enables determining rotation angles of the corrected base coordinate systems when rotation of the of the initial base coordinate system due to variation of the displacement occurring in different positions at the recovery boiler is calculated based on the measured displacements in the at least two different positions.

### EXAMPLE

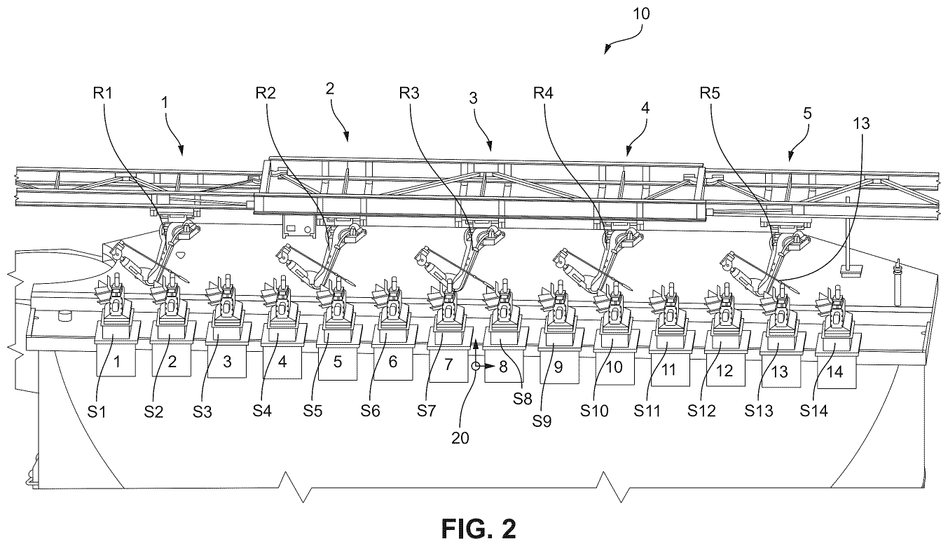

In this example which configuration is shown in FIG. 2 the maintenance operation apparatus 10 takes care of cleaning smelt spouts S1-S14 of a recovery boiler 11 by applying the method according to the invention. It includes five tool moving devices R1-R5 that are, in this example, articulated industrial robots. As can be seen from the figure the recovery boiler 11 has, in this case, fourteen smelt spouts S1-S14. Thus, each robot R1-R5 needs to clean only at most three smelt spouts which ensures that turnaround time of the cleaning process remains short compared e.g., to a case where only one tool moving apparatus would be used for these all. The smelt spouts S1-S14 have been divided to each robot R1-R5 in manner described in table 1 below.

TABLE 1
Smelt spouts division to the robots R1-R5

| | |
|---|---|
| Smelt spouts S1-S3 | Robot R1 |
| Smelt spouts S4-S6 | Robot R2 |
| Smelt spouts S7-S8 | Robot R3 |
| Smelt spouts S9-S11 | Robot R4 |
| Smelt spouts S12-S14 | Robot R5 |

### World Coordinate System

Displacements of the smelt spouts S1-S14 occurring due to the thermal expansion are determined in a world coordinate system 20 that locates in a fixed position. In case of a single robot, robot's frame attachment point and world coordinate system are typically placed at a same position. In multirobot case, as herein, the world coordinate system 20 for each robot R1-R5 is positioned at a predetermined point which is the same for each robot. In this example the world coordinate system 20 has been placed in between the two middle-most smelt spouts S7 and S8.

### Initial Base Coordinate Systems

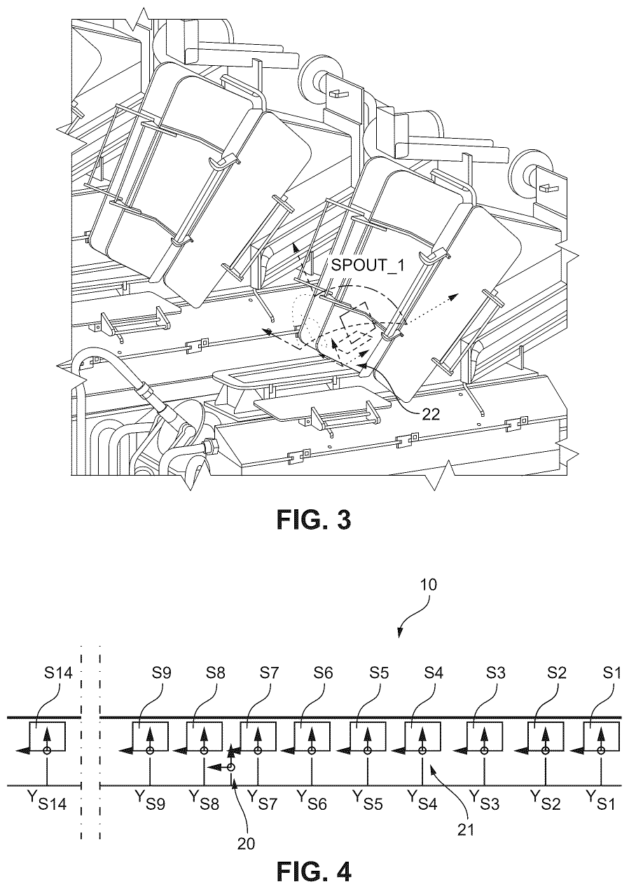

Cleaning movements of the smelt spouts S1-S14 are realized in a corrected base coordinate system (also called “work coordinate system”) 22. In this example, initial base coordinate systems 21 and corrected base coordinate systems 22 are positioned as shown in the FIG. 3 (i.e., at the smelt spouts S1-S14 lower end). Alternatively, they can be positioned in any suitable place, for instance to a plate having a hole provided that the positions are considered in calculations accordingly. Anyway, positions and orientations of the initial base coordinate systems 21 are corrected by applying principles described above to form corrected base coordinate systems 22 which then compensates effects of the thermal expansion in controlling of the smelt spouts cleaning operations.

FIG. 4 shows how the initial base coordinate systems 21 have been chosen in this example. Origins of the initial base coordinate systems 21 are defined in world coordinate system 20. In practice they can be determined e.g., by a real robot and smelt spout cleaning tool by applying following procedure:
1 The smelt spout cleaning tool 13 is moved close to the respective smelt spout S1-S14 by means of the respective robot's R1-R5 regular control program,
2 From the close position the smelt spout cleaning tool S1-S14 is moved to a desired point by controlling the respective robot R1-R5 manually,
3 At the desired position the coordinates are defined as an origin of the respective initial base coordinate system 21 in a world coordinate system 20, and
4 The coordinates are saved to the memory of the control unit of the maintenance operation apparatus 10 as an origin of the respective initial coordinate system 21.

### Displacements and Corrected Base Coordinate Systems

Displacements occurring at the recovery boiler 11 (which mostly occurs at the recovery boiler wall 12) due to thermal expansion is, in this case, measured by using three measurement sensors M1-M3 in three dimensions (X, Y and Z). The measurement sensors M1-M3 can be any suitable measurement sensors being able to measure or determine position directly (e.g., optical sensors or cameras) or indirectly (e.g., strain gages or other kind of displacement sensors). Because of the displacement also the positions of the smelt spouts S1-S14 change. These changes are compensated by controlling the movements of the respective smelt spout cleaning tools 13 in corrected base coordinate systems 22 wherein the displacements are considered.

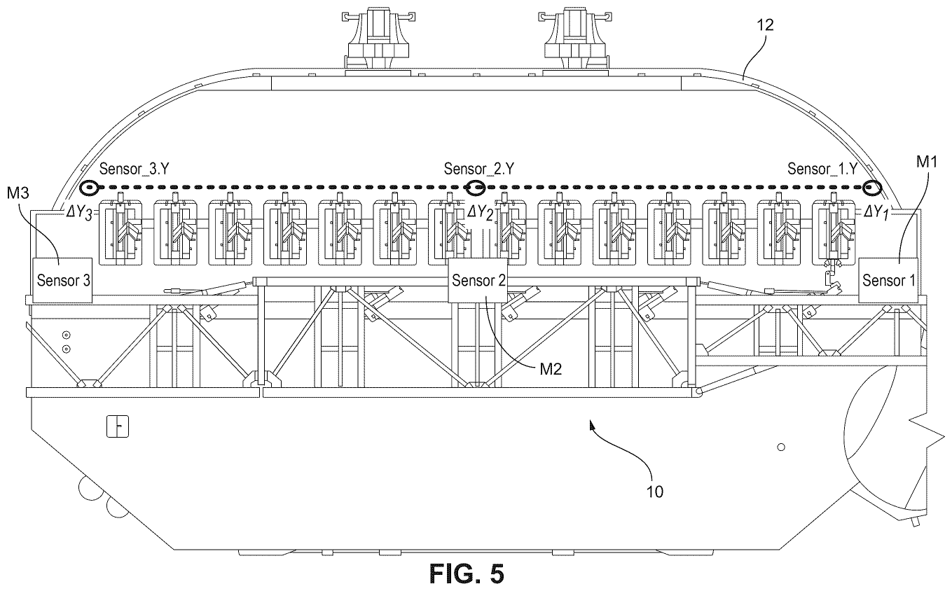

Positions of the measurement sensors M1, M2 and M3 are shown in the FIG. 5. As can be seen from FIG. 5, in this example, Y direction denotes to the horizontal direction being transverse to the longitudinal direction of the smelt spouts S1-S14. Thus, thermal expansion causing displacement in Y direction changes distances between adjacent spouts S1-S14 as well as between the measurement sensors M1, M2 and M3 being in this example as shown in the FIG. 5. It should be also notified that changes of distances between the measurement sensors in Y direction (i.e., ΔY₁, ΔY₂, ΔY₃) effects also into calculation of displacements in X and Z directions since these distances are used also in calculation of rotation in respect of Z and X axes.

Changed distances between the measurement sensors in Y direction can be calculated for the spouts S1-S7 in the following manner:

$$M {1}^{′} ( Y ) = M 1 ( Y ) + Δ {Y}_{1} \qquad ( 6 )$$

$$M {2}^{′} ( Y ) = M 1 ( Y ) + Δ {Y}_{2} \qquad ( 7 )$$

$${M}^{′} 12 dist = ABS ( M {1}^{′} ( Y ) - M {2}^{′} ( Y ) ) \qquad ( 8 )$$

wherein
M1′ (Y) is changed Y coordinate of sensor M1
M2′ (Y) is changed Y coordinate of the measurement sensor M2
M1(Y) is original Y coordinate of the measurement sensor M1
M2(Y) is original Y coordinate of the measurement sensor M2
ΔY₁ is displacement of the measurement sensor M1 in Y direction
ΔY₂ is displacement of the measurement sensor M2 in Y direction
M12′dist is changed distance between the measurement sensors M1 and M2
and for the smelt spouts S8-S14

$$M {1}^{′} ( Y ) = M 1 ( Y ) + Δ Y 1 \qquad ( 9 )$$

$$M {2}^{′} ( Y ) = M 1 ( Y ) + Δ Y 2 \qquad ( 10 )$$

$$M {23}^{′} dist = ABS ( M {1}^{′} ( Y ) - M {2}^{′} ( Y ) ) \qquad ( 11 )$$

wherein
M3′ (Y) is changed Y coordinate of the measurement sensor M3,
M3(Y) is original Y coordinate of the measurement sensor M3,
ΔY3 is displacement of sensor M3 in Y direction,
M23′dist is changed distance between measurement sensors M2 and M3.

Thus, if it is considered that thermal expansion is uniform in Y direction the displacements of the smelt spouts S1-S14 in Y direction can be calculated from equations

$${Y}^{′} si = \frac{Ysi}{M 12 dist ( y )} \times M {12}^{′} dist ( Y ) , i = 1 … 7 \qquad ( 11 )$$

$${Y}^{′} si = \frac{Ysi}{M 23 dist ( y )} \times M {23}^{′} dist ( Y ) , i = 8 … 14 \qquad ( 12 )$$

$$Δ Ysi = {Y}^{′} si - Ysi , i = 1 … 14 \qquad ( 13 )$$

wherein
Y′si is Y coordinate of the smelt spout Si after occurrence of the thermal expansion,
Ysi is Y coordinate of the smelt spout Si before occurrence of the thermal expansion.

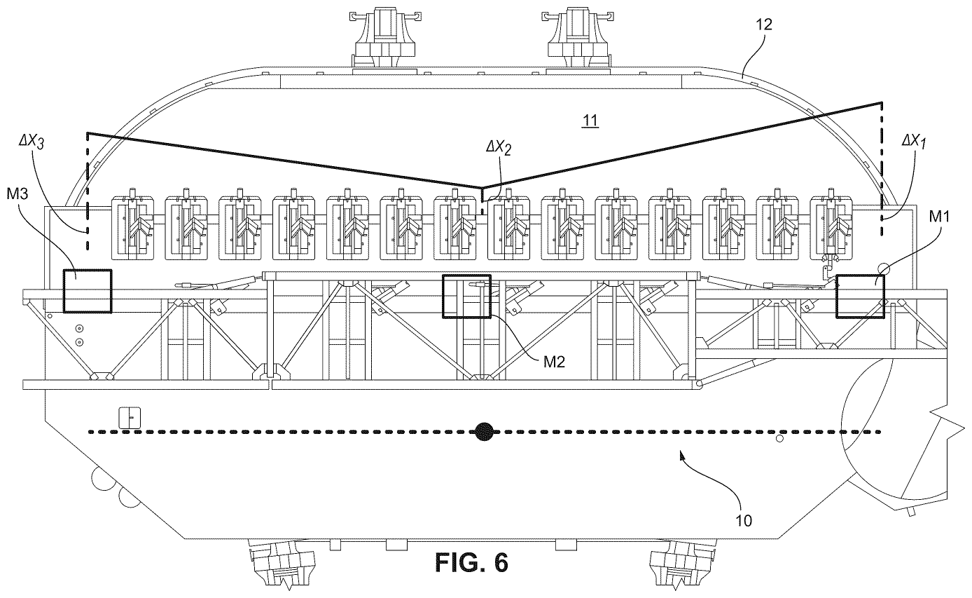

The recovery boiler wall 12 may also twist in respect of Z-axis which causes that amount of displacement occurring at adjacent smelt spouts in X direction vary. FIG. 6 shows a situation where the displacements in X direction ΔX1, ΔX2 and ΔX3 of the measurement sensors M1, M2 and M3 in the FIG. 6 are not equal. In such case the wall has twisted in respect of Z axis and displacement due to thermal expansion for each smelt spout S1-S14 must be calculated separately.

In region of spouts S1-S7 the rotation angle A1 of the wall can be calculated from equation

$$A 1 = arctan \frac{( Δ X 1 - Δ X 2 )}{M {12}^{′} dist ( Y )} \qquad ( 14 )$$

wherein
ΔX₁ is displacement of the measurement sensor M1 in X direction
ΔX₂ is displacement of the measurement sensor M2 in X direction
M12′dist(Y) is distance between the sensors in Y direction after occurrence of the displacement

Respectively in region of smelt spouts S8-S14 the rotation angle A2 can be calculated from equation

$$A 2 = arctan \frac{( Δ X 2 - Δ X 3 )}{M {23}^{′} dist ( Y )} \qquad ( 15 )$$

wherein
ΔX3 is displacement of the measurement sensor M3 in X-direction
M23′dist(Y) is distance between the sensors in Y-direction after occurrence of the thermal expansion.

When the rotation angles A1 and A2 are known displacements of each spout S1 . . . S14 in X direction can be calculated from equations

$$Δ Xsi = Δ X 2 + tan A 1 \cdot Ysi ( i = 1 … 7 ) \qquad ( 16 )$$

$$Δ Xsi = Δ X 2 + tan A 2 \cdot Ysi ( i = 8 … 14 ) \qquad ( 17 )$$

wherein
ΔXsi is displacement of the smelt spout Si caused by the rotation of the recovery boiler wall 12 in respect of axis X
Ysi is the distance of the smelt spout Si in Y direction from the origin of the world coordinate system 20.

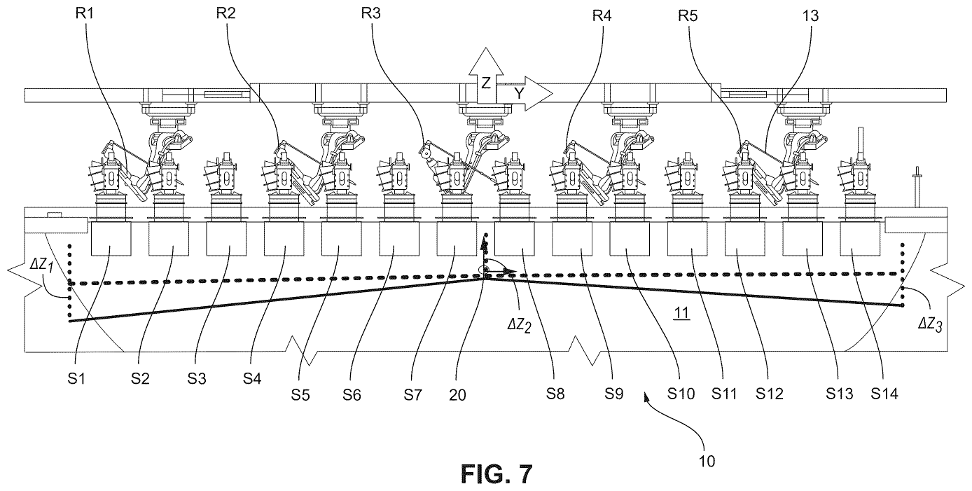

The recovery boiler wall 12 may further twist in respect of X axis which causes that amount of displacement occurring at adjacent spouts in Z direction vary. FIG. 7 shows a situation where the displacements in Z direction ΔZ1, ΔZ2 and ΔZ3 of the measurement sensors M1, M2 and M3 in the FIG. 7 are not equal. In such case the wall has twisted in respect of X axis, and displacement in Z direction for each smelt spout S1-S14 must be calculated separately.

In region of smelt spouts S1-S7 the rotation angle C1 of the wall in respect of X axis can be calculated from equation

$$C 1 = arctan \frac{( Δ Z 1 - Δ Z 2 )}{M {12}^{′} dist ( Y )} \qquad ( 18 )$$

wherein
ΔX1 is displacement of the measurement sensor M1 in X direction
ΔX2 is displacement of the measurement sensor M2 in X direction
M12′dist(Y) is distance between the sensors in Y direction after occurrence of the thermal expansion.

Respectively in region of smelt spouts S8-S14 the rotation angle A2 can be calculated from equation

$$C 2 = arctan \frac{( Δ Z 1 - Δ Z 2 )}{M {23}^{′} dist ( Y )} \qquad ( 19 )$$

wherein
ΔZ3 is displacement of the measurement sensor M3 in X direction,
M23′dist(Y) is distance between the sensors in Y direction.

When the rotation angles C1 and C2 are known displacements in Z direction of each smelt spout S1 . . . . S14 can be calculated from equations

$$Δ Zsi = Δ Z 2 + tan C 1 \cdot Ysi , when i = 1 … 7 \qquad ( 20 )$$

$$Δ Zsi = Δ Z 2 + tan C 2 \cdot Ysi , when i = 8 … 14 \qquad ( 21 )$$

wherein
ΔZsi is displacement of a smelt spout Si in Z direction caused by the rotation of the wall in respect of axis X
Ysi is the distance of a smelt spout Si in Y direction from the origin of the world coordinate system 20.

Thus, by using these equations displacements ΔXSi, ΔYSi and ΔZSi of each smelt spouts S1-S14 can be calculated in directions of all the three coordinate axes X, Y and Z. Thus, also the positions and orientation of corrected base coordinate systems 22 (i.e., work coordinate systems) which in this example coincide with the smelt spouts Si can be determined in the world coordinate system 20 by adding to the coordinates of the respective initial base coordinate systems 21 the respective displacement in each direction (i.e., ΔXSi, ΔYSi and ΔZSi) and considering the angles of the coordinate axes (i.e., angles A1, A2, C1 and C2).

Therefore, by applying the corrected base coordinate systems 22 determined in the above-described manner the robots R1 . . . R5 can be controlled to carry out cleaning movements of the smelt spout cleaning tools 13 in such a way that all the effects of the thermal expansion are compensated, and the uncertainty of the control caused by the thermal expansion can be avoided.

Doubtlessly, the method of controlling a maintenance operation apparatus according to the invention may be realized in several different ways differing from the above-described example. For instance, positions of each initial base coordinate systems can be chosen differently, and which also has effect on the corrected base coordinate systems. In case of different maintenance objects to be maintained the control method may be adapted according to its characteristics. For example, in case of inspecting a hatch the initial base coordinate system may be positioned in one of its corners or other suitable position, preferably into such position into which its determination by using the respective maintenance tool moving device (e.g., a robot) can be done reproducibly (i.e., which includes some physical point of discontinuity against which the maintenance tool can be moved by using the tool moving device).

Consequently, the invention is not limited to the above-described embodiments but can vary within the scope of the appended claims.

1. A method of controlling a maintenance operation apparatus of a recovery boiler to carry out a maintenance operation for an at least one maintenance object at a recovery boiler, wherein the maintenance operation apparatus comprises a maintenance tool and a tool moving device for configured to move the maintenance tool to accomplish the maintenance operation, and wherein the method comprises:
a) defining a position of a fixed world coordinate system at the recovery boiler;
b) defining a position of an initial base coordinate system of the at least one maintenance object that is at a chosen point of the at least one maintenance object determined in the fixed world coordinate system in an initial temperature of the recovery boiler;
c) defining a position of a corrected base coordinate system of the at least one maintenance object that is at the chosen point of the at least one maintenance object determined in the fixed world coordinate system in a transited temperature of the recovery boiler; and
d) controlling the tool moving device to carry out the maintenance operation of the at least one maintenance object in the corrected base coordinate system.

2. The method according to claim 1, wherein the position of the corrected base coordinate system is determined by the tool moving device by controlling the tool moving device to move the maintenance tool to the position of the chosen point of the at least one maintenance object in transited temperature and recording the coordinates of the chosen point in the fixed world coordinate system.

3. The method according to claim 1, wherein the position of the corrected base coordinate system is determined at least partly by calculating the displacement of the initial base coordinate system caused by thermal expansion of a recovery boiler wall due to the temperature transition.

4. The method according to claim 1, wherein at least the fixed world coordinate system is three-dimensional Cartesian coordinate system and the determination of the position coordinates of the corrected base coordinate system is calculated using following equations:
$${X}^{′} = X + Δ X$$
$${Y}^{′} = Y + Δ Y$$
$${Z}^{′} = Z + Δ Z$$
wherein
X′, Y′, Z′ coordinates are position coordinates of the corrected base coordinate system in the fixed world coordinate system,
X, Y, Z coordinates are position coordinates of the initial base coordinate system in the fixed world coordinate system, and
ΔX, ΔY, ΔZ are position coordinate displacements of the of the initial base coordinate system due to the thermal expansion in the fixed word coordinate system.

5. The method according to claim 4, wherein the method further comprises controlling of the maintenance operation of at least two maintenance objects arranged adjacent to each other at the recovery boiler.

6. The method according to claim 5, wherein a Y axis denotes a direction along a line between the at least two, adjacent maintenance objects, a X axis denotes a direction perpendicular to the Y axis in the same plane as the X axis, and a Z axis denotes a direction perpendicular to a plane defined by X and Y axes.

7. The method according to claim 4, wherein the position coordinate displacements ΔX, ΔY, ΔZ include rotation of coordinate axes of the initial base coordinate system due to rotation of the recovery boiler wall caused by the thermal expansion.

8. The method according to claim 7, wherein rotation angles A and C of the coordinate axes of the initial base coordinate system due to rotation of the recovery boiler wall caused by the thermal expansion are determined by equations:
$$A = arctan ( Δ X 2 - Δ X 1 ) / ( Y 2 - Y 1 )$$
$$C = arctan ( Δ Z 2 - Δ Z 1 / ( Y 2 - Y 1 ) ,$$
wherein
A is a rotation angle of Y-axis in respect of X-axis
C is rotation angle of Y-axis in respect of Z-axis
Y1 is a first Y position
Y2 is a second Y position
ΔX1 is displacement in the X direction occurring in the position Y1
ΔX2 is displacement in the X direction occurring in the position Y2
ΔZ1 is displacement in the Z direction occurring in the position Y1, and
ΔZ2 is displacement in the Z direction occurring in the position Y2.

9. The method according to claim 5, further comprising determining one initial base coordinate system and one corrected base coordinate system per each of the at least two maintenance objects.

10. The method according to claim 5, wherein the tool moving device is controlled to carry out the maintenance operation for each of the at least two maintenance objects in a respective corrected base coordinate system for the each of the at least two maintenance objects.

11. The method according to claim 1, further comprising measuring a displacement occurring at the recovery boiler caused by the temperature transition is measured by at least one displacement measuring sensor placed in a known position at the recovery boiler.

12. The method according to claim 11, wherein measurement results of the at least one displacement measurement sensor is used in determination of the displacement of the position of the initial base coordinate system to determine the position of the corrected base coordinate system.

13. The method according to claim 11, further comprising determining displacements occurring in at least two different positions at the recovery boiler using at least two displacement sensors placed in at least two different positions.

14. The method according to claim 13, wherein rotation of the of the initial base coordinate system due to variation of the displacement occurring in the at least two different positions at the recovery boiler is determined based on measured displacements in the at least two different positions.

15. The method according to claim 1, wherein the maintenance operation is at least one of: smelt spout cleaning, liquor gun opening cleaning or inspection hatch opening cleaning, and
wherein the maintenance tool is respectively one of: a smelt spout cleaning tool, a liquor gun opening cleaning tool or an inspection hatch opening cleaning tool.

16. A maintenance operation apparatus configured to carry out at least one maintenance operation for an at least one maintenance object at a recovery boiler wall, wherein the apparatus comprises;
a maintenance tool, a tool moving device configured to move the maintenance tool, and
a control device configured to:
a) defining a position of a fixed world coordinate system at the recovery boiler;
b) defining a position of an initial base coordinate system of the at least one maintenance object that is at a chosen point of the at least one maintenance object determined in the fixed world coordinate system in an initial temperature of the recovery boiler;
c) defining a position of a corrected base coordinate system of the at least one maintenance object that is at the chosen point of the at least one maintenance object determined in the fixed world coordinate system in a transited temperature of the recovery boiler; and
d) controlling the tool moving device to carry out the maintenance operation of the at least one maintenance object) in the corrected base coordinate system.

17. The maintenance operation apparatus according to claim 16, wherein the tool moving device includes is an articulated industrial robot.

18. The maintenance operation apparatus according to claim 16, wherein the maintenance operation apparatus comprises at least one displacement measuring sensor configured to measure a displacement of the recovery boiler.
